(19) United States
(12) Patent Application Publication
(10) Pub. No.: US 2025/0038452 A1
(43) Pub. Date: Jan. 30, 2025

(54) Plug connector module for a modular plug connector, and plug connector which has such a plug connector module

(71) Applicant: HARTING Electric Stiftung & Co. KG, Espelkamp (DE)

(72) Inventors: Jeffrey PAWLICKI, Plainfield, IL (US); Julie RUTTER, Elgin, IL (US); Wade FOURNIER; Ingo SIEBERING, Kirchlengern (DE)

(73) Assignee: HARTING Electric Stiftung & Co. KG, Espelkamp (DE)

(21) Appl. No.: 18/837,489

(22) PCT Filed: Jan. 30, 2023
(86) PCT No.: PCT/DE2023/100067

§ 371 Date: Aug. 9, 2024

(30) Foreign Application Priority Data
Feb. 11, 2022 (DE) 10 2022 103 205.1

(51) Int. Cl. H01R 13/514; H01R 4/20; H01R 11/32; H01R 13/10; H01R 13/405

(52) U.S. Cl. CPC H01R 13/514; H01R 4/20; H01R 11/32; H01R 13/10; H01R 13/405

(57) ABSTRACT

A plug connector module for a modular industrial plug has a connection side for connecting a conductor of a cable, in particular a multi-wire cable, and a contact side for electrically connecting to a mating plug connector module. Precisely one connection opening for a conductor of the cable is provided on the connection side, and at least two contact openings are provided on the contact side for accessing a mating plug connector module. The plug connector module has a bridge contact element which has precisely one connection region for an electric conductor, and the connection region is paired with the connection opening, wherein the bridge contact element has at least two contact regions for contacting a respective mating contact element of a mating plug connector module, and each contact region is paired with a contact opening.

### CROSS-REFERENCE TO RELATED APPLICATION

This application is a national stage application, filed under 35 U.S.C. § 371, of International Patent Application PCT/DE2023/100067, filed on Jan. 30, 2023, which claims the benefit of German Patent Application DE 10 2022 103 205.1, filed on Feb. 11, 2022.

### TECHNICAL FIELD

The disclosure relates to a plug connector module for a modular industrial plug connector and to a plug connector which uses a plug connector module.

### BACKGROUND

Plug connector modules are needed as a constituent part of a plug connector modular system, in order to be able to adapt a plug connector, in particular a heavy industrial plug connector, flexibly to specific requirements with regard to the transmission of signals and energy, for example between two electric devices. Usually, plug connector modules are inserted into corresponding holding frames, which occasionally are also designated as hinged frames, module frames or modular frames, for this purpose. The holding frames are thus used to accommodate a plurality of mutually identical and/or also different plug connector modules and to fasten these securely to a surface and/or a device wall and/or in a plug connector housing, and so on.

The plug connector modules usually each have a substantially cube-shaped insulating body or a cube-shaped housing. These insulating bodies or housings can, for example, be used as contact carriers and accommodate and fix contact elements of an extremely wide range of types. The function of a plug connector formed as a result is therefore very flexible. It is possible, for example, for pneumatic modules, optical modules, modules for transmitting electrical energy and/or electric analog and/or digital signals to be accommodated in the respective insulating body or housing, and thus be used in the plug connector modular system. Increasingly, plug connector modules also perform measurement and data tasks.

Optimally, use is made of holding frames which are formed from two frame halves, which are connected to each other by hinges. The plug connector modules are provided with approximately rectangular holding means projecting on the narrow sides. Provided in the side parts of the frame halves are cut-outs formed as openings closed on all sides, into which the holding means dip as the plug connector modules are introduced into the holding frame. To introduce the plug connector modules, the holding frame is folded open, i.e. opened, wherein the frame halves are folded open about the hinges only to such an extent that the plug connector modules can be inserted. The frame halves are then folded together, i.e. the holding frame is closed, wherein the holding means enter the cut-outs and secure, form-fitting retention of the plug connector modules in the holding frame is effected.

The above-described modular industrial plug connectors offer high flexibility and can be configured for an extremely wide range of areas of use, in that plug connector modules with different functions are installed with one another in a common holding frame. However, the number of plug connector modular spaces in a holding frame is limited. As a result, the flexibility of an industrial plug connector is limited.

The housings of the known plug connector modules all have substantially the same geometry, at least with regard to their width and length within the fixing plane of the hinged frame. The reason for this is that each plug connector module must be insertable into each installation space in the holding or hinged frame.

Modular plug connectors of this type are also used in so-called data centers. Here, the currents of individual conductors of a multi-way cable must frequently be distributed within the plug connector. For example, the so-called neutral conductor of the connected cable within a data rack must be distributed to the server units of the data rack. For this purpose, on the connection side, for example, the neutral conductor has been distributed to two plug connector modules with the aid of a separate bridge conductor. Such tailoring is complicated and wastes space in the plug connector or in its holding frame.

### SUMMARY

The present application discloses a plug connector module which further increases the flexible usability of a modular plug connector.

The improved plug connector module is intended to be used in modular industrial plug connectors. The plug connector module is intended to be inserted with other identical and different plug connector modules into a holding frame which, in turn, is installed, generally screwed, into a plug connector housing.

The plug connector module has a connection side, to which a conductor of an in particular multi-way cable is connected. The plug connector module additionally has a contact side, which is intended for the electrical connection to a mating plug connector module of a mating plug connector or a socket.

Exactly one connection opening for the conductor of the cable is provided on the connection side of the plug connector module. “Exactly one” means that only one (and not two or more) connection opening is provided. On the contact side of the plug connector module, on the other hand, there are at least two contact openings for the access to a suitable mating plug connector module.

The plug connector module has a bridge contact element, in particular for the equalization of the potential of an electrical installation. The bridge contact element has exactly one connection region for the electric conductor. The connection region is assigned to the connection opening of the plug connector module.

Furthermore, the bridge contact element has at least two contact regions, which are each intended to make electric contact with a mating contact element of a mating plug connector module. Each contact region is assigned to a contact opening of the plug connector module.

In a preferred embodiment, the bridge element has exactly two contact regions. In this way, the spatial relationships of the plug connector module and the size of grounding contact elements or PE contact elements are used optimally.

The connection region of the bridge contact element is advantageously formed as a crimp sleeve. By using this, the stripped end of the conductor is crimped. Contacting a conductor in this way is sufficiently well known and considered to be particularly industrially firm.

The at least two contact regions of the bridge contact element are preferably each formed as a socket. The socket is substantially cylindrical and comprises axially protruding fins, which are curved slightly radially inward. Contact pins of a mating plug connector module are accommodated in the sockets.

Advantageously, the plug connector module has a two-part housing, consisting of two individual housing halves. In this way, the plug connector module can be produced simply and cost-effectively. The two housing halves can be latched to each other and have corresponding latching means for this purpose.

Preferably, the connection region of the bridge contact element is fastened approximately centrally to a first side of a metallic bridge rail. Ideally, the envisaged position of the connection region is exactly central on the bridge rail.

Advantageously, the contact regions of the bridge element are each arranged on the outside or at the ends of a second side of the bridge rail. Such an arrangement has a positive effect on the air clearances and creep distances of the plug connector module.

In a preferred embodiment, the connection region of the bridge contact element is screwed or riveted to its bridge rail. Preferably, the contact regions are also each screwed or riveted to the bridge rail. A screw fixing is in particular electrically very stable, whereas riveting offers production advantages.

Preferably, the connection region and the bridge rail are formed from different metallic materials. Furthermore, the contact regions and the bridge rail can also be formed from different metallic materials, wherein the contact regions always consist of the same metallic material. Overall, the bridge contact element can accordingly be formed from three different materials. The materials can be selected in accordance with the intended use.

These advantages are provided by the multi-part design of the bridge contact element.

### BRIEF DESCRIPTION OF THE DRAWINGS

An exemplary embodiment of the invention is illustrated in the drawings and is explained in more detail below.

FIG. 1 shows a perspective illustration of a plug connector housing of a modular industrial plug connector,

FIG. 2 shows a perspective illustration of a holding frame populated with various plug connector modules, and

FIG. 3 shows an exploded drawing of a plug connector module for use in an industrial plug connector.

### DETAILED DESCRIPTION

The figures include partly simplified schematic illustrations. To some extent, identical designations are used for the same but possibly non-identical elements. Different views of the same elements can be scaled differently. Directional statements such as, for example, “left”, “right”, “top” and “bottom” are to be understood with reference to the respective figure and can vary with respect to the object illustrated in the individual illustrations.

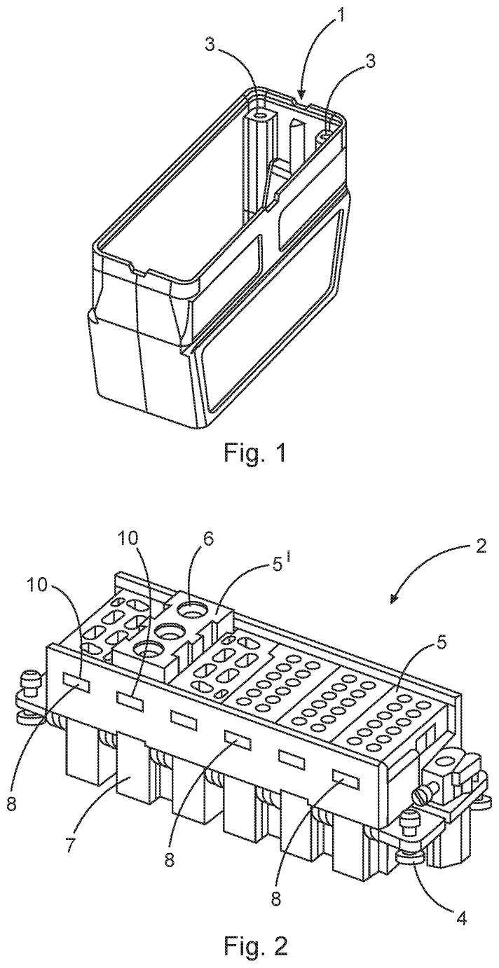

FIG. 1 shows a plug connector housing 1 of an industrial plug connector. The plug connector housing 1 usually consists of a metallic material and is produced in particular in a zinc pressure diecasting process. Such a plug connector housing 1 is robust and has good electromagnetic shielding properties and is therefore particularly suitable for rough industrial environments.

A holding frame 2 populated with various plug connector modules 5, 5′ can be seen in FIG. 2. The holding frame 2 has a frame-like shape and comprises two frame halves 9 connected to each other by hinges. The holding frame 2 has respective screws 4 in its corner regions. The plug connector housing 1 has an approximately rectangular cross section and has corresponding threaded holes 3 in its corner regions in the interior of the housing. The holding frame 2 can be fastened in the plug connector housing 1 via the screws 4 in interaction with the associated threaded holes 3.

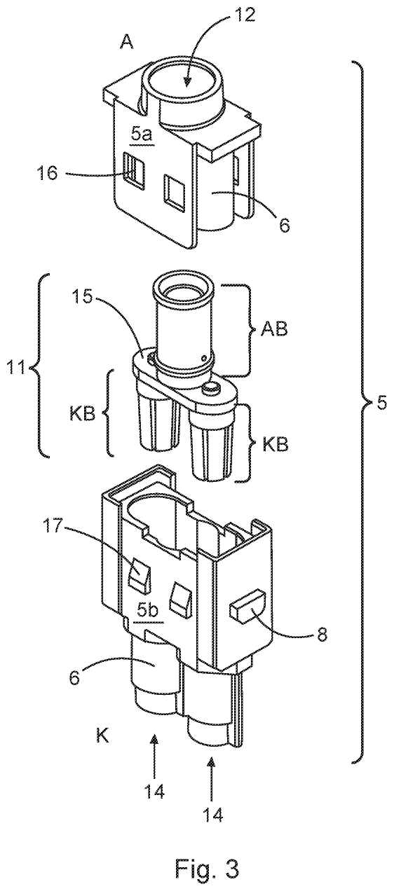

An exploded drawing of a plug connector module 5 can be seen in FIG. 3. The plug connector module is intended for a modular industrial plug connector. The plug connector module 5 has a connection side A, to which a conductor (not shown) of an in particular multi-way cable (not shown) is connected. To this end, the conductor stripped at the end is inserted into a connection opening 12 and crimped to the connection region AB of the bridge contact element 11.

The plug connector module 5 has a contact side K, which is intended for the electrical connection to a mating plug connector module or to a mating contact element (neither shown). To this end, the mating contact elements access contact openings 14 in the contact region KB of the bridge contact element 11.

The connection region AB of the bridge contact element 11 is formed as a crimp sleeve and, accordingly, has an approximately hollow cylindrical form, wherein the cylinder base is riveted to a bridge rail 15. The contact regions KB of the bridge contact element 11 each have the outline of an axially multiply slit hollow cylinder, wherein the slits form contact fins which are bent somewhat radially inward. The cylinder base is riveted onto the bridge rail 15.

The plug connector module 5 comprises a first housing half 5a and a second housing half 5b and accordingly has a two-part housing. The housing halves 5a, 5b can be reversibly latched to each other. To this end, the second housing half 5b has latching hooks 17, which latch into corresponding latching windows 16 in the first housing half 5a.

### LIST OF REFERENCE NUMBERS

1 Plug connector housing
2 Holding frame
3 Threaded hole
4 Screw
5,5′ Plug connector module
   5a) First housing half of the plug connector module
   5b) Second housing half of the plug connector module
6 Contact chamber
8 Holding means
9 Frame half
10 Opening
11 Bridge contact element
12 Connection opening
14 Contact opening
15 Bridge rail
16 Latching window
17 Latching hook
A Connection side
K Contact side
AB Connection region
KB Contact region

1.-11. (canceled)

12. A plug connector module (5, 5′) for a modular industrial plug connector, comprising:
a connection side (A) for connecting a conductor of a multi-way cable; and
a contact side (K) for an electrical connection to a mating plug connector module;
exactly one connection opening (12) for the conductor of the multi-way cable provided on the connection side (A);
at least two contact openings (14) for access of the mating plug connector module provided on the contact side (K); and
a bridge contact element (11), which has exactly one connection region (AB) for the conductor,
wherein the connection region (AB) is assigned to the connection opening (12), and
wherein the bridge contact element (11) has at least two contact regions (KB), each for making contact with a mating contact element of the mating plug connector module,
wherein the contact regions (KB) are each assigned to one of the at least two contact openings (14).

13. The plug connector module (5, 5′) as claimed in claim 12,
wherein the contact bridge element (11) has exactly two contact regions (KB).

14. The plug connector module (5, 5′) as claimed in claim 12,
wherein the connection region (AB) of the bridge contact element (11) is formed as a crimp sleeve.

15. The plug connector module (5, 5′) as claimed in claim 12,
wherein the contact regions (KB) of the bridge contact element (11) are each formed as a socket.

16. The plug connector module (5, 5′) as claimed in claim 12,
wherein the plug connector module (5, 5′) has a two-part housing, consisting of two housing halves (5a, 5b).

17. The plug connector module (5, 5′) as claimed in claim 16,
wherein the two housing halves (5a, 5b) can be latched to each other.

18. The plug connector module (5, 5′) as claimed in claim 12,
wherein the connection region (AB) of the bridge contact element (11) is fastened centrally to a first side of a metallic bridge rail (15), and
wherein the contact regions (KB) of the bridge contact element (11) are each arranged at ends of a second side of the metallic bridge rail (15).

19. The plug connector module (5, 5′) as claimed in claim 18,
wherein the connection region (AB) is screwed or riveted to the metallic bridge rail (15).

20. The plug connector module (5, 5′) as claimed in claim 18,
wherein the contact regions (KB) are each screwed or riveted to the metallic bridge rail (15).

21. The plug connector module (5, 5′) as claimed in claim 18,
wherein the connection region (AB) and the metallic bridge rail (15) are made of different metallic materials,
and/or
wherein the contact regions (KB) are made of a first metallic material and the metallic bridge rail (15) is made of a second metallic material.

22. A plug connector, comprising:
a plug connector housing (1);
a holding frame (2); and
at least one plug connector module (5, 5′) as claimed in claim 12.
